(19) United States
(12) Patent Application Publication
(10) Pub. No.: US 2015/0287106 A1
(43) Pub. Date: Oct. 8, 2015

(54) Captive Portal Service Offerings

(71) Applicant: CenturyLink Intellectual Property LLC, Denver, CO (US)

(72) Inventors: Steven M. Casey, Littleton, CO (US); Felipe Castro, Erie, CO (US); Kevin M. McBride, Lone Tree, CO (US)

(21) Appl. No.: 14/678,398

(22) Filed: Apr. 3, 2015

Related U.S. Application Data
(60) Provisional application No. 61/976,630, filed on Apr. 8, 2014.

(51) Int. Cl. G06Q 30/02

(52) U.S. Cl. CPC G06Q 30/0277; G06Q 30/0269

(57) ABSTRACT

A captive portal service offering system includes an advertising server hosting at least one captive portal service offering page, a registration server configured to provide user account information associated with a user account, and an interface device associated with the user account. The interface device is configured to retrieve, from the registration server, user account information. Based on the user account information, the interface device determines whether to present the at least one captive portal service offering page to the at least one client device. In response to the determination, the interface device directs at least one client device to the at least one captive portal service offering page. The interface device receives a user selection of the network service offered by the at least one captive portal service offering page and transmits the user selection to the registration server.

### CROSS-REFERENCES TO RELATED APPLICATIONS

This application claims priority to U.S. Provisional Patent Application Ser. No. 61/976,630 (the “'630 application”), filed on Apr. 8, 2014 by Steven M. Casey, et al. (attorney docket no. 020370-016801US), entitled, “Captive Portal Service Offering via a Modem, Residential Gateway, NID, or Other Interface Device,” the disclosure of which is incorporated herein by reference in its entirety and for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to provisioning broadband internet services, and more particularly to methods, systems, and computer software for providing captive portal service offerings via a residential gateway or other network interface device.

### BACKGROUND

Conventionally, when new services or upgrades to existing services become available to a customer, a service provider, such as an internet service provider (ISP), would notify the potential customers about the new services or upgrades. Most often, ISPs directly notify their customers of the new services or upgrades through physical mail (i.e. the postal service), email, leaving physical notices door-to-door at a customer's premises, or by telephone. Several drawbacks are inherent to the existing ways of contacting customers, including, but not limited to, the costs associated with the printing and mailing physical notices, and the need for personnel to call customers or distribute physical notices. Furthermore, none of the existing methods provides any form of assurance that the customer will even acknowledge the notices. A physical notice sent in the mail may be discarded without ever having been opened by the customer. Email notices may be filtered, ignored, or discarded without ever being opened by a customer. Physical notices left at a customer premises may be displaced during adverse weather conditions, remain undiscovered, ignored, or otherwise discarded by the customer. Telephone calls may be screened, blocked, or ignored by a customer.

Increasingly, public internet access is offered at wireless access points, such as Wi-Fi hotspots, and in various public spaces and businesses. Wi-Fi hotspots allow devices or users, connected to the wireless access point, to purchase internet access from an internet service provider controlling Wi-Fi hotspot. Before access is granted to the service provider network, the service provider may redirect individual devices to a captive portal. For example, the captive portal may be used to have a user acknowledge and agree to various terms and conditions before receiving access to a service provider network. Payment and other identifying information may also be requested via a captive portal page. Thereafter, an authorized device or user may connect to and access the service provider network. Thus, each user is presented with and must at least navigate the captive portal in order to gain access to the service provider network.

However, the particular captive portal is only presented when the user connects to the particular access point, while other publicly available access points and private networks may not implement captive portals altogether. Moreover, the captive portal cannot identify the connecting users as individual customers of the service provider, and captive portals associated with a particular access point are presented identically to the users.

Thus, a more efficient way to directly notify a customer of new services and upgrades available to that customer, and to have the customer acknowledge the notifications, is provided below.

### BRIEF SUMMARY

The various embodiments provided below include, without limitation, methods, systems, and/or software products. Merely by way of example, a method might comprise one or more procedures, any or all of which are executed by a computer system. Correspondingly, an embodiment might provide a computer system configured with instructions to perform one or more procedures in accordance with methods provided by various other embodiments. Similarly, a computer program might comprise a set of instructions that are executable by a computer system (and/or a processor therein) to perform such operations. In many cases, such software programs are encoded on physical, tangible, and/or non-transitory computer readable media (such as, to name but a few examples, optical media, magnetic media, and/or the like).

In one aspect, a captive portal service offering system may be implemented. The system may include an advertising server hosting at least one captive portal service offering page. The advertising server may be configured to both send and receive captive portal service offering pages. The system may also include a registration server configured to provide user account information associated with a user account, the user account information indicating whether the user account qualifies for a network service offered by the at least one captive portal service offering page, and to register the user account for the network service offered by the at least one captive portal service offering page. The system may further include an interface device that is associated with the user account and in communication with at least one client device. The interface device may include at least one processor non-transitory computer readable media having encoded thereon computer software comprising a set of instructions executable by the at least one processor to perform one or more operations.

The set of instructions may include: instructions to retrieve user account information, associated with the user account, from the registration server; instructions to determine whether to present the at least one captive portal service offering page to the at least one client device based on the user account information; instructions to direct, in response to a determination to present the at least one captive portal service offering page, one or more of the at least one client device to the at least one captive portal service offering page; instructions to receive a user selection of the network service offered by the at least one captive portal service offering page via the at least one captive portal service offering page; and instructions to transmit the user selection to the registration server.

In accordance with one set of embodiments, the interface device may further be operable to transmit an identifier of the at least one client device to the registration server, and to associate the at least one client device with the user account. In another set of embodiments, the interface device may further be operable to receive at least one captive portal service offering page from the advertising server. The interface device may then direct a connected client device to the at least one captive portal service offering page. In yet another set of embodiments, the interface device may include instructions to establish a tunnel into a walled garden, in which access by the at least one client device is restricted to the walled garden, and where the least one client device is redirected, via the tunnel, to the captive portal server in the walled garden.

In another aspect, a device for captive portal service offerings is provided. The device may be associated with a user account and in communication with at least one client device. The device may include at least one processor, and non-transitory computer readable media having encoded thereon computer software comprising a set of instructions executable by the at least one processor to perform one or more operations.

The set of instructions may include instructions that cause the device to retrieve, from a registration server, user account information associated with the user account; instructions to determine, based on the user account information, whether to present the at least one captive portal service offering page to the at least one client device. In response to the determination, the device may direct one or more of the at least one client device to display the at least one captive portal service offering page. The device may receive a user selection of the network service offered by the at least one captive portal service offering page through selections on the captive portal service offering page. The device may then transmit the user selection to the registration server.

In accordance with various embodiments, the device may transmit an identifier of the at least one client device to the registration server; and associate the at least one client device with the user account. In some embodiments, the device may receive, from an advertising server, the at least one captive portal service offering page and direct the at least one client device to the at least one captive portal service offering page received by the device. In a further embodiment, the device may establish a tunnel into a walled garden, restrict access by the at least one client device to the walled garden, and redirect the at least one client device through the tunnel to a captive portal server in the walled garden, wherein the captive portal server presents the at least one captive portal service offering page to the at least one client device, and wherein the captive portal server receives the at least one captive portal service offering page from the advertising server.

In a further aspect, a method for providing captive portal service offerings is provided. The method includes providing an interface device associated with a user account. A connection may be established, via the interface device, with at least one client device. The interface device may retrieve, via a registration server, user account information associated with the user account. The interface device may then determine, based on the user account information, whether to present at least one captive portal service offering page to the at least one client device. The method further includes directing, via the interface device, the at least one client device to the at least one captive portal service offering page, receiving a user selection of a network service offered by the at least one captive portal service offering page, and transmitting the user selection to the registration server.

According to some embodiments, the method may further include receiving, with the interface device, the at least one captive portal service offering page, and storing, at the interface device, the at least one captive portal service offering page locally, wherein the at least one client device is directed to the at least one captive portal service offering page stored on the interface device. In another embodiment, the method may include establishing a tunnel into a walled garden, restricting access by the at least one client device to the walled garden, and redirecting the at least one client device to a captive portal server in the walled garden. The captive portal server may then present the at least one captive portal service offering page to the at least one client device, as received from the advertising server. In further embodiments, the method may also include providing the at least one captive portal service offering page as part of a video stream to the at least one client device.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram of a system for providing captive portal service offerings locally from a residential gateway, network interface device, or other interface device, in accordance with various embodiments.

FIG. 2 is a block diagram of a system for providing captive portal service offerings via a walled garden, in accordance with various embodiments.

FIG. 3 is a flow diagram of a method for providing captive portal service offerings locally, in accordance with various embodiments.

FIG. 4 is a flow diagram of a method for providing captive portal service offerings via a walled garden, in accordance with various embodiments.

FIG. 5 is a block diagram of a computer architecture for providing captive portal service offerings, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

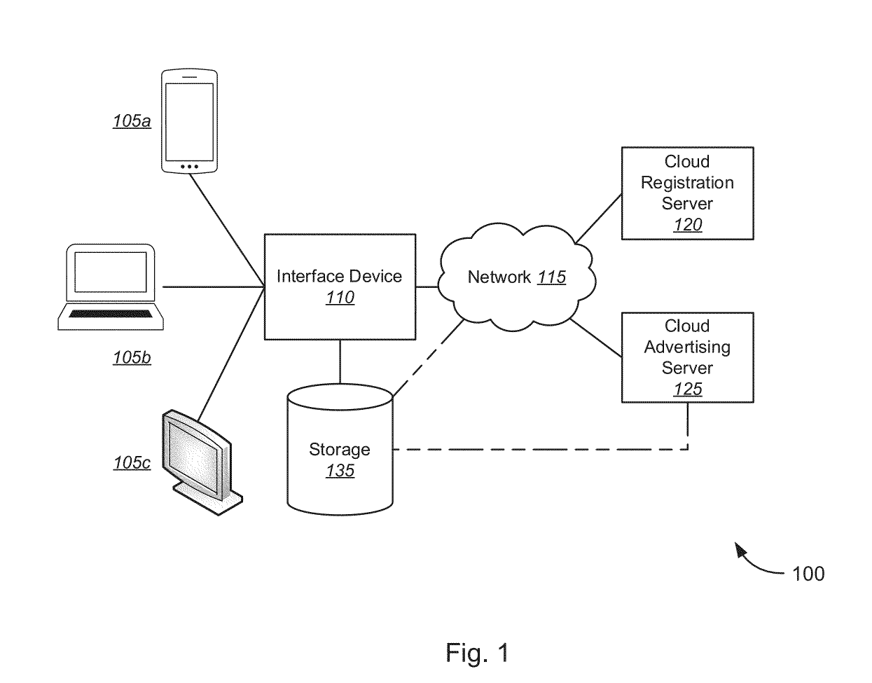

The accompanying descriptions of FIGS. 1-5 are provided for purposes of illustration and should not be considered to limit the scope of the different embodiments. FIGS. 1-5 may refer to examples of different embodiments corresponding various stages and components of the captive portal service offering system, which can be considered alternatives or which can be used in conjunction with one another in the various embodiments.

Various embodiments described herein, while embodying (in some cases) software products, computer-performed methods, and/or computer systems, represent tangible, concrete improvements to existing technological areas, including, without limitation, network communications technology, network access (and/or restriction) technology, network configuration technology, and/or the like. In other aspects, certain embodiments, can improve the functioning of a computer system itself (e.g., computing devices or systems that form parts of the network, computing devices or systems for performing the functionalities described below, etc.), for example, by enabling implementation of content/services/applications access determination, enabling implementation of content/services/applications access or restriction, and/or the like. In particular, to the extent any abstract concepts are present in the various embodiments, those concepts can be implemented as described herein by devices, software, systems, and methods that involve specific novel functionality (e.g., steps or operations), such as implementing content/services/applications access determination, implementing content/services/applications access or restriction, implementing virtualization functionalities for performing these implementations, enabling functionality for a 3rd party provider to access, maintain, modify, and/or control aspects of an access provider's network or computing systems, and/or the like, to name a few examples, that extend beyond mere conventional computer processing operations. This functionality can produce tangible results outside of the implementing computer system, including, merely by way of example, blocking a user's access to certain content, applications, and/or services over a network, enabling a user to access certain content, applications, and/or services over a network on a charge per access basis, reducing network access speeds for a user while accessing certain content, applications, and/or services over a network, enabling a 3^{rd} party provider more direct and assertive control of the 3^{rd} party provider's delivery of content, applications, and/or services to consumers through the access provider's network and/or computing systems, and/or the like.

FIG. 1 is a block diagram of a system 100 for providing captive portal service offerings locally from a residential gateway (RG), network interface device (NID), or other interface device, in accordance with various embodiments. Interface device 110 is used to generically represent an RG, NID, or other interface device, alone or in combination. Thus, interface device 110 may be any device, or combination of devices, in the device chain between a client device 105 and service provider network 115. The interface device 110 may be configured to allow a client device 105 to communicate with a service provider network 115.

In various embodiments, the system 100 may be utilized to provide one or more captive portals containing one or more service offerings. These captive portal pages are referred to as service offering pages. The service offerings include offers to purchase, subscribe to, or upgrade various network services provided by the ISP or other service provider. Network services may include, without limitation, broadband internet services, television service, voice/telephone service, mobile broadband service, various app services, etc. Thus, in various embodiments, service offering pages notify customers to the availability of the various network services and also include service offerings to upgrade or add new services. For example, service offerings may include, without limitation, offers to upgrade the service speed for existing broadband internet service (i.e. from 50 megabits per second (mbps) to 1 gigabit per second (gbps)), add television or voice service, upgrade a streaming video service to stream high-definition (HD) media content, renew a subscription, add a new channel to existing television service, and the like. The service offerings may indicate pricing information, and other terms related to the specific services offered. In some further embodiments, service offerings may be created by a third-party service provider, and provided to an ISP by the third-party service provider. The ISP may then distribute the service offerings to the customers via a captive portal service offering page.

The system 100 includes a plurality of client devices 105a, 105b, 105c (105 collectively) in communication with interface device 110. As depicted, each of the customer client devices 105 is coupled to a single interface device 110. However, in other embodiments, multiple sets of client devices 105 may be connected to their own respective interface device 110. For example, one set of client devices 105 may include a smartphone 105a, personal computer 105b, and television 105c connected to a first interface device 110. Another set of client devices may similarly include a smartphone, personal computer, and television, but may be connected to a separate RG device. In various embodiments, each of the separate sets of client devices 105 may be coupled to a common NID via their own respective RGs. Alternatively, each RG may be coupled to a separate respective NID. In various embodiments, RGs may include, without limitation, a modem, router, switch, voice over internet protocol (VoIP) adapter, set-top box, or other like device. NIDs may include, among other devices, an optical network terminal (ONT). In further embodiments, the interface device 110 may also include, without limitation, a digital subscriber line access multiplexer (DSLAM), cable modem termination system (CMTS), or optical line termination (OLT).

The system 100 further includes a registration server 120 and advertising server 125. According to a set of embodiments, the registration server 120 and advertising server 125 communicate with the interface device 110 through a network 115. The network 115 may include a local area network (“LAN”), including without limitation a fiber network, or an Ethernet network; a wide-area network (“WAN”), including without limitation a service provider network, a cloud network, and the internet; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol, or any other wireless protocol; or any combination of these or other networks. The interface device 110 may further be coupled to electronic storage 135. According to one set of embodiments, the electronic storage 135 may be local, internal storage for the interface device 110. In other embodiments, the electronic storage 135 may be an external device, separate from the interface device 110, such as, for example, a cloud storage device accessible through network 115. Alternatively, in some embodiments, the electronic storage 135 may communicate with the advertising server 125, directly or through network 115. Thus, electronic storage 135 may include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including, without limitation, various file systems, database structures, or the like.

In various embodiments, the system 100 is operable to present captive portal service offering pages to customer client devices 105 connected to the interface device 110. According to one set of embodiments, the advertising server 125 may host various service offering pages, and is able to both transmit and receive service offering pages. For example, in some embodiments, the advertising server 125 may be able to receive, or otherwise configured to allow a third party service provider to create, service offering pages. The advertising server 125 may also host service offering pages created by the ISP or other service provider in control of the advertising server 125. The advertising server 125 may then transmit the service offering pages to electronic storage 135. In various embodiments, the advertising server 125 may transmit the service offering pages to the electronic storage 135 in bulk, or may only transmit the service offering pages as they apply to a specific interface device 110 associated with electronic storage 135. Alternatively, the advertising server 125 may provide the service offering pages as requested by the interface device 110. In various embodiments, the service offering pages may be specifically formatted to display properly on respective client devices 105. For example, some service offering pages may be formatted to display on a smartphone or tablet, while other service offering pages are formatted to be displayed on a computer display, or television.

According to a set of embodiments, the registration server 120 is configured to retrieve user account information associated with individual user accounts. In various embodiments, the user account information may indicate information associated with a particular user account or a group of multiple accounts. For example, user account information may include, without limitation, an indication of what services are available to a user account or group of related user accounts, what services a user account currently receives, what service providers provide what services to the user account, whether a new service is available for a user account, or whether an upgrade to a service currently received by the user account is available. In further embodiments, user account information may also indicate, without limitation, whether a new service or upgrade to existing service is available to a group of user accounts, such as user accounts belonging to customers in a particular geographic area, multi-dwelling unit, residential subdivision, or other group of customers collectively serviced by the ISP or other service provider.

Thus, the registration server 120 may determine a user account associated with an interface device 110. In various embodiments, the registration server 120 may receive identifying information from the interface device 110. The identifying information may include, without limitation, point-to-point protocol (PPP) credentials that are unique to each respective interface device 110, a network address, media access control address, telephone number, or other similar identifying information. Based on the identifying information, the registration server 120 may determine a user account associated with the interface device 110. Registration server 120 may then retrieve the user account information associated with the user account, and provide the user account information to a requesting interface device 110 or alternatively, may indicate to the interface device 110 that a new service or upgrade is available to the customer. In some further embodiments, the user account information may also be associated with at least one client device. For example, in various embodiments, the interface device 110 may an identifier of at least one client device to the registration server to associate with the user account information. Identifiers for the at least one client device may include information similar to identifying information for the interface device 110, such as, but not limited to, a network address, media access control address, electronic serial number, mobile equipment identifier, international mobile equipment identity, international mobile subscriber identity, or other similar identifiers as known in the art. Thus, the user account information may be used to present captive portal service offering pages as appropriately formatted for the associated client devices, as described above.

According to one set of embodiments, the interface device 110 may then present applicable service offering pages, as a captive portal, to the various client devices 105. For example, in one set of embodiments, the user account information may indicate that a user account associated with the interface device 110 currently receives broadband internet service at a speed of 50 mbps. Suppose that an ISP recently laid down fiber optic lines to the customer's premises, and that fiber optic connectivity is newly available to the customer. Whereas, conventionally, the ISP would have had to rely on traditional means of notifying the customer to the newly available services offered by switching to the fiber optic connection, the interface device 110 may now look up the user account information, and based on the user account information, recognize that the new fiber optic connection allows the customer to upgrade their internet speed—for purposes of this example—up to 1 gbps, and that television service is newly available over the fiber optic connection. Based on the user account information, the interface device 110 may then provide the connected client devices 105 with one or more captive portal service offering pages containing service offerings for the upgraded internet speed and newly available television service. In various embodiments, the interface device 110 may first alert the client device to the availability of a new service or upgrade before presenting the captive portal service offering page. For example, an alert may include, without limitation, an audible alert, a graphical alert displayed on a screen of the client device, an indicator light (i.e. a light emitting diode on a mobile phone), a vibration, or other like indication. In other embodiments, the captive portal service offering page may itself serve as an alert, for example, by being presented in the form of a popup alert. From the perspective of the client devices 105, the client devices may merely be redirected from a web browser, or presented with a popup or graphical overlay of the captive portal service offering page. In the various embodiments, the service offering pages may be obtained by the interface device 110 from local or external electronic storage 135, or by requesting them from advertising server 125 selectively or in bulk. Alternatively, the advertising server 125 may push the appropriate service offering pages to the interface device 110 or electronic storage 135 automatically based on user account information, or the service offering pages may be pushed in bulk to the interface device 110 or electronic storage 135 for the interface device 110 to present as appropriate.

In yet another embodiment, the interface device 110 may include a set-top box. The set-top box 110 may be configured to provide a video stream to the client device 105c, for example a live television broadcast, or video-on-demand (VoD) content, among others. In various embodiments, when it is determined to display a captive portal service offering page, the set-top box 110 may present the captive portal service offering page as a popup, picture-in-picture, or graphical overlay. The captive portal service offering page may be displayed alongside, or over the video stream. For example, in some embodiments, only part of the screen space may be occupied by the captive portal service offering page. Alternatively, the captive portal service offering page may take up the entire screen space, the captive portal service offering page being displayed instead of the video stream altogether.

In various embodiments, the customer may be prevented from navigating away from the captive portal service offering page until the customer submits a user selection responsive to the service offering. Acceptable user selections may include, without limitation, acceptance of the service offering, dismissal of the captive portal service offering page, rejection of the service offering, or indicating a desire to be reminded of the service offering at a later time.

The interface device 110 may then receive the user selections responsive to the service offerings, and transmit the user selections to the registration server 120. The registration server 120 may then handle the user selections as indicated by the interface device 110. For example, in one set of embodiments, if the user selection indicates an acceptance of the service offering, the registration server 120 may register the user account to receive the new service or upgrade indicated by the service offering. If the user selection indicates a rejection of the service offering, the registration server 120 may update the user account information to reflect the customer's lack of interest in the service. In further embodiments, the registration server 120 may flag the user account information to withhold the service offering from being presented to the customer indefinitely or for a specified period of time. If the user selection indicates a desire to be reminded of the service offering at a later time, the registration server 120 may similarly update the user account information to cause the service offering to be presented at a later time as indicated by the user selection.

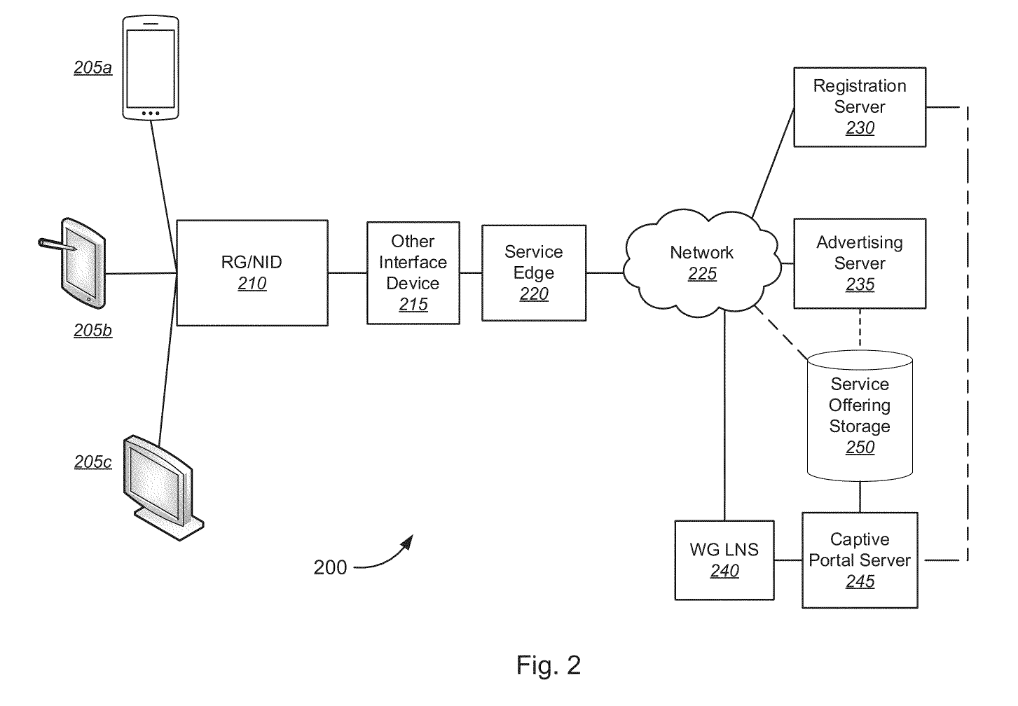

The above embodiments of system 100 pertain to an architecture where the interface device 110 provides the captive portal service offering pages to the client devices 105 locally, or otherwise provided directly by the interface device 110 to the client devices 105. An alternative architecture is depicted in FIG. 2 utilizing a walled garden (WG) architecture to present captive portal service offerings. Thus, FIG. 2 is a block diagram of a system 200 for providing captive portal service offerings via a WG, in accordance with various embodiments. The hardware and network elements depicted by the RG/NID 210 include, without limitation, an RG, NID, or a combination of both. Hardware and network elements depicted generically by other interface device 215 include, without limitation, devices capable of communicating with multiple sets of RG/NIDs 210, such as a DSLAM, CMTS, OLT, or other like devices. Service edge device 220 may include, without limitation, a broadband remote access server (BRAS), broadband network gateway (BNG), or other edge device.

Turning to the system 200, client devices 205a, 205b, 205c (205 collectively) are each coupled directly to a respective RG/NID 210. As described above, in one set of embodiments, the RG/NID 210 may be residential gateway, or NID to which each of the client devices 205 are coupled. In other embodiments, multiple sets of client devices 205 belonging to different customers may be connected respectively to multiple RG/NIDs 210. For example, one set of client devices 205 may include a smartphone 205a, personal computer 205b, and television 205c connected to a first RG/NID 210. In various embodiments, each of the separate sets of client devices 205 may be coupled to a common NID via their own respective RGs. Alternatively, each RG may be coupled to a separate respective NID. The RG/NID 210 is in turn optionally coupled to other interface 215. In various embodiments, the other interface device 215 may include devices configured to communicate with one or more RG/NID 210, such as a DSLAM, CMTS, or OLT. The other interface device 215 may be coupled to a service edge device 220. In various embodiments, the service edge device may include, without limitation, a BRAS or other edge device configured to couple the RG/NID 210 or other interface device 215 to the edge of a service provider network, such as network 225.

The system 200 further includes a registration server 230 and advertising server 235. According to a set of embodiments, the registration server 230 and advertising server 235 may communicate with a captive portal server 245 and electronic storage device 250. The captive portal server 245 may, in turn, communicate with client devices 205 via network 225. The network 225 may include a local area network (“LAN”), including without limitation a fiber network, or an Ethernet network; a wide-area network (“WAN”), including without limitation a service provider network, a cloud network, and the internet; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol, or any other wireless protocol; or any combination of these or other networks. According to some embodiments, the electronic storage 250 may be local, internal storage for the captive portal server 245. In other embodiments, the electronic storage 250 may be an external device, separate from the captive portal server 245, such as, for example, a cloud storage device accessible through network 225. Alternatively, in some embodiments, the electronic storage 250 may communicate with the captive portal server 245, directly or through network 225. Thus, electronic storage 250 may include, without limitation, a disk drive, a drive array, an optical storage device, a solid-state storage device.

In various embodiments, the system 200 is operable to present captive portal service offering pages to customer client devices 205 presented by the captive portal server 245 via a WG. As described in FIG. 1, according to some embodiments, the advertising server 235 may host various service offering pages, and is able to both transmit and receive service offering pages. In some embodiments, the advertising server 235 may be able to receive, or otherwise configured to allow a third party service provider to create, service offering pages. The advertising server 235 may also host service offering pages created by the ISP or other service provider in control of the advertising server 235. The advertising server 235 may then transmit the service offering pages to electronic storage 250. In various embodiments, the advertising server 235 may transmit the service offering pages to the electronic storage 250 in bulk, or may only transmit the service offering pages as they apply to a specific RG/NID 210, or client devices connected to the WG. Alternatively, the advertising server 235 may provide the service offering pages as requested by captive portal server 245. In various embodiments, the service offering pages may be specifically formatted to display properly on respective client devices 205. For example, some service offering pages may be formatted to display on a smartphone 205a or tablet 205b, while other service offering pages are formatted to be displayed on a computer display, or television 205c.

According to a set of embodiments, the registration server 230 is configured to retrieve user account information associated with individual user accounts. In various embodiments, the user account information may indicate information associated with only the particular user account or alternatively with a group of multiple accounts.

Thus, the registration server 230 may determine a user account associated with an RG/NID 210. In various embodiments, the registration server 230 may receive identifying information of an RG/NID 210 from the captive portal server 245. Alternatively, the registration server 230 may receive the identifying information via the service edge device 220. The identifying information may include, without limitation, point-to-point protocol (PPP) credentials that are unique to each respective RG/NID 210, a network address, media access control address, telephone number, or other similar identifying information of the RG/NID 210. Based on the identifying information, the registration server 230 may determine a user account associated with the interface device 205. Registration server 230 may then retrieve the user account information associated with the user account, and provide the user account information to the requesting captive portal server 245, or may indicate to a service edge device 220 that a new service or upgrade is available to the customer to redirect the customer to the WG captive portal server 245.

According to one set of embodiments, the identifying information from the RG/NID 210 is transmitted to registration server 230 by service edge device 220. The registration server 230 may then authenticate the identifying information against a database, for example, a lightweight directory access protocol (LDAP) database. In one set of embodiments, the registration server 230 may authenticate the identifying information internally against a locally stored database file to identify a user account associated with the identifying information. In another set of embodiments, the registration server 230 may authenticate the identifying information against an external LDAP database. In various embodiments, the registration server 230 may identify additional user account information related to the user account. User account information may include, without limitation, an indication of what services are available to a user account or group of related user accounts, what services a user account currently receives, what service providers provide what services to the user account, whether a new service is available for a user account, or whether an upgrade to a service currently received by the user account is available. In further embodiments, user account information may also indicate, without limitation, whether a new service or upgrade to existing service is available to a group of user accounts, such as user accounts belonging to customers in a particular geographic area, multi-dwelling unit, residential subdivision, or other group of customers collectively serviced by the ISP or other service provider.

According to one set of embodiments, the user account information may also indicate that a user account has been flagged to be redirected to a WG. In response to detecting that a WG flag has been set, the registration server 230, service edge device 220, or combination of both registration server 230 and service edge device 220 may restrict access to network 225 from the RG/NID 210, and traffic from RG/NID 210 may be limited to a WG. According to an alternative set of embodiments, the registration server 230, service edge device 220, or a combination of both registration server 230 and service edge device 220, may set a WG flag only in response to determining that a new service or upgrade is available to the user account.

In various embodiments, connectivity to the network 225 may be authorized based on the authentication of the user account. Thus, in various embodiments, RG/NID 210 may be associated with user accounts that have been flagged to have access restricted to a walled-garden via the WG layer 2 tunneling protocol network server (LNS) 240. Therefore, in response to identifying that the user account is flagged for WG redirect, in various embodiments, the service edge device 220 may establish a layer 2 tunneling protocol (L2TP) tunnel to the WG LNS 240, and an L2TP session is initiated. The WG LNS 240 may then direct traffic originating from the RG/NID 210 to the MDU captive portal server 235. In various embodiments, the captive portal server 235 may also optionally be coupled to the registration server 230. Thus, in various embodiments, the captive portal server 235 hosts the MDU walled garden and delivers the captive portal service offering pages stored in electronic storage 250.

According to one set of embodiments, the registration server 230 may include, without limitation, a remote authentication dial-in user service (RADIUS) system, or a terminal access controller access-control system (TACACS). It will be appreciated by those skilled in the art that other authentication systems may be utilized that are capable of authenticating access to the ISP network by RG/NID 210 or connected client devices 205, and that authentication servers are not limited to RADIUS or TACACS based systems.

In various embodiments, the captive portal service offering page may take the form of a portal for service activation. The service offering page may present configuration options for the customer to configure their services, as well as an interface to receive payment information from the customer. Configuration options may include, without limitation, offers to purchase, subscribe to, or upgrade various network services provided by the ISP or other service provider. Network services may include, without limitation, broadband internet services, television service, voice/telephone service, mobile broadband service, various app services, etc. Thus, in various embodiments, service offering pages notify customers to the availability of the various network services and also include service offerings to upgrade or add new services. For example, service offerings may include, without limitation, offers to upgrade the service speed for existing broadband internet service (i.e. from 50 megabits per second (mbps) to 1 gigabit per second (gbps)), add television or voice service, upgrade a streaming video service to stream high-definition (HD) media content, renew a subscription, add a new channel to existing television service, and the like. The service offerings may indicate pricing information, and other terms related to the specific services offered. In some further embodiments, service offerings may be created by a third-party service provider, and provided to an ISP by the third-party service provider. The ISP may then distribute the service offerings to the customers via a captive portal service offering page. The customer may then select their desired speed of service based on these options.

In the various embodiments, the service offering pages may be obtained by the captive portal server 245 from local or external electronic storage 250, or by requesting them from advertising server 235 selectively or in bulk. Alternatively, the advertising server 235 may push the appropriate service offering pages to the captive portal server 245 or electronic storage 250 automatically, based on user account information, or the service offering pages may be pushed in bulk to the captive portal server 245 or electronic storage 250 for the captive portal server 245 to present as applicable to the particular RG/NID 210 or user account.

In various embodiments, the customer may be prevented from navigating away from the captive portal service offering page until the customer submits a user selection responsive to the service offering. Acceptable user selections may include, without limitation, acceptance of the service offering, dismissal of the captive portal service offering page, rejection of the service offering, or indicating a desire to be reminded of the service offering at a later time.

The captive portal server 245 may then receive the user selections responsive to the service offerings, and transmit the user selections to the registration server 230. The registration server 230 may then handle the user selections as indicated by the captive portal server 245. For example, in one set of embodiments, if the user selection indicates an acceptance of the service offering, the registration server 230 may register the user account to receive the new service or upgrade indicated by the service offering. In one set of embodiments, upon receiving payment information, the captive portal server 245 may communicate the selection of configuration options to the registration server 230 to update the user account information to reflect the configuration options and register the user account to receive the selected services.

If the user selection indicates a rejection of the service offering, the registration server 230 may update the user account information to reflect the customer's lack of interest in the service. In further embodiments, the registration server 120 may flag the user account information to withhold the service offering from being presented to the customer indefinitely or for a specified period of time. If the user selection indicates a desire to be reminded of the service offering at a later time, the registration server 230 may similarly update the user account information to cause the service offering to be presented at a later time as indicated by the user selection.

Based on the updates to the user account information, the registration server 230 may then indicate to the service edge device 220 whether to allow RG/NID 210 to access the network 225, or to again redirect the RG/NID 210 to the WG. In some embodiments, the captive portal server 245 may be a revenue extraction gateway (RXG), or other similar device.

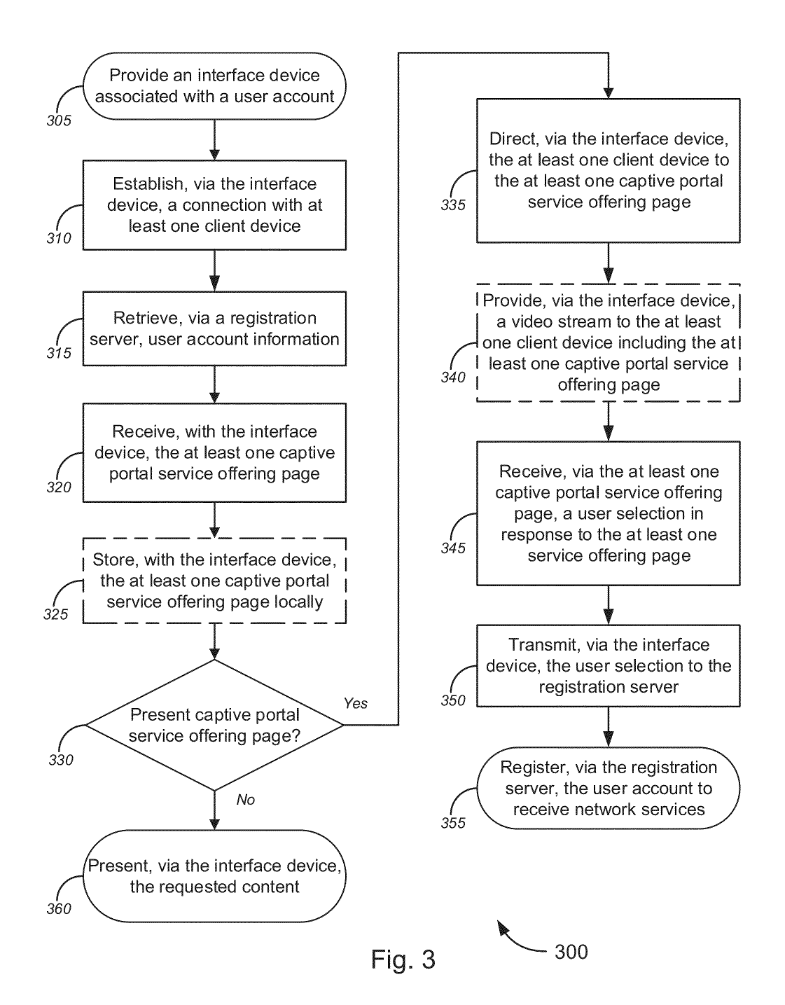

FIG. 3 is a flow diagram of a method 300 for providing captive portal service offerings locally from an RG, NID, or other interface device, in accordance with various embodiments. The method 300 begins, at block 305, by providing an interface device associated with a user account. As described above, with respect to FIG. 1, the interface device may be any device, or combination of devices, in the device chain between a client device and service provider network, that allows a client device to access and communicate with a service provider network.

At block 310, a connection is established, by the interface device, with at least one client device. In some embodiments, the client devices may have already been connected to the interface device beforehand, for example, being powered back on. In other embodiments, the client devices may be connecting to the interface device for the first time. For example, in one set of embodiments, the interface device may be a modem to which a device reconnects, or connects to for the first time.

At block 315, user account information is retrieved from a registration server by the interface device. According to a set of embodiments, the registration server is configured to retrieve user account information associated with individual user accounts. User account information may indicate information associated with a particular user account or a group of multiple accounts, such as an indication of what services are available to a user account or group of related user accounts, and whether a new service or upgrade is available to a user account. In further embodiments, user account information may also indicate, without limitation, whether a new service or upgrade is available based on a set of attributes indicated by the user account information. Attributes may include, without limitation, a particular geographic region or area, a multi-dwelling unit, residential subdivision, a street address, entire towns, geographic coordinates, or other form of identifying a customer, or group of customers collectively, serviced by the ISP or other service provider.

In various embodiments, the registration server may determine a user account associated with an interface device based on identifying information from the interface device. The identifying information may include, without limitation, point-to-point protocol (PPP) credentials that are unique to each respective interface device, a network address, media access control address, telephone number, or other similar identifying information. In other embodiments, the identifying information may originate from one or more of the client devices coupled to the interface device. The registration server may then retrieve the user account information associated with the user account, and provide the user account information to a requesting interface device or alternatively, may indicate to the interface device that a new service or upgrade is available to the customer.

At block 320, at least one captive portal service offering page is received via the interface device. In various embodiments, an advertising server may, able to both transmit and receive service offering pages transmits the service offering pages to the interface device. The advertising server may transmit the service offering pages to the interface device or a storage device in bulk, or may transmit only the service offering pages that specifically apply to the interface device. Alternatively, the advertising server may provide the service offering pages only upon request by the interface device. In various embodiments, the service offering pages may be transmitted in multiple formats to display properly on various client devices.

At optional block 325, the interface device stores the at least one captive portal service offering page. According to a set of embodiments, the interface device may have a storage device for locally storing the service offering pages. In various embodiments, the storage device may be internal storage, such as a hard drive, or alternatively, the storage device may be removable computer media. In various other embodiments, the storage device may be a remote or external to the interface device. For example, as detailed with respect to the embodiments described above, the storage device may be a cloud storage device accessible via a service provider network, the internet, or other like network.

At decision block 330, it is determined whether to present a captive portal service offering page to the client device. According to one set of embodiments, a registration server may determine a user account associated with the interface device. In various embodiments, the registration server may receive identifying information from the interface from which the registration server may determine a user account. The registration server may then retrieve the user account information associated with the user account, and provide the user account information to the requesting interface device. In one set of embodiments, the user account information may indicate that a user account associated with interface device currently receives broadband internet service. The interface device may then determine whether to present applicable captive portal service offering pages, and what service offering pages are applicable to present.

At block 360, if it is determined not to present the captive portal service offering page to the client devices, the interface device allows the client device to access content normally, as requested. At block 335, if it is determined to present a service offering page, the client devices are directed to one or more service offering pages that contain applicable service offerings. Continuing with the above example, if the user account information indicates that the customer receives broadband internet service, the service offering pages may contain offers to upgrade the internet speed of the broadband internet service, or to add television and telephone service. In some embodiments, multiple service offerings may be presented in the form of separate service offering pages. In other embodiments, a single service offering page may contain all or a portion of the multiple service offerings. In various embodiments, the client device may be directed to the service offering pages upon startup, or connection to the interface device. In some embodiments, the client devices may be presented with the service offering pages in the form of a popup or graphical overlay presented over the content requested by the client device. In yet further embodiments, the client devices may be redirected from the content currently being viewed to the service offering page.

At optional block 340, if the interface device is a set-top box, the set-top box is configured to provide a video stream to the client device, where the video stream includes at least one captive portal service offering page. In various embodiments, the set-top box may present the captive portal service offering page as a popup, picture-in-picture, or graphical overlay. The captive portal service offering page may be displayed alongside, or over the video stream. In some embodiments, only part of the screen space may be occupied by the captive portal service offering page. Alternatively, the captive portal service offering page may take up the entire screen space, or may supplant the video stream altogether.

At block 345, the interface device may receive, via the at least one service offering page, a user selection indicating a response to the at least one service offering page. In various embodiments, the customer may be prevented from navigating away from the captive portal service offering page until the customer submits a user selection responsive to the service offering. User selections may include, without limitation, acceptance of the service offering, selection of various configuration options, dismissal of the captive portal service offering page, rejection of the service offering, or an indication to be reminded of the service offering at a later time.

At block 350, the user selection is transmitted by the interface device, to the registration server, as it is received by the interface device through the service offering page. At block 355, the registration server may register the user account to receive a network service, as indicated by the user selection. In various embodiments, the registration server may be configured to implement the user selections. For example, in one set of embodiments, the user selection may indicate an acceptance of the service offering, and the registration server may register the user account to receive the new service or upgrade as indicated by the user selection, or to implement various configuration options as indicated by the user selection. In some embodiments, these selections may also be reflected by updates to the user account information. If the user selection indicates a rejection of the service offering, the registration server may update the user account information to reflect the customer's lack of interest in the service. In further embodiments, the registration server update the user account information to indicate that the service offering page should be withheld from being presented to the customer indefinitely, or for a specified period of time, if, for example, the customer wishes to be reminded of the service offering at a later time.

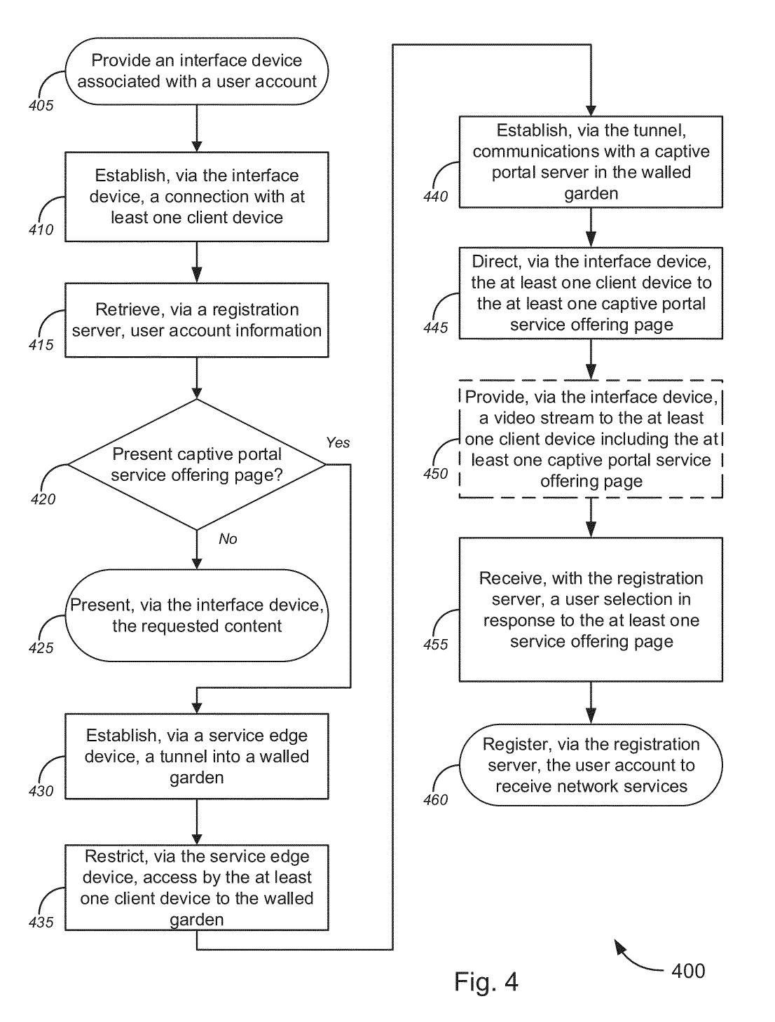

FIG. 4 depicts a flow diagram of a method 400 for providing captive portal service offerings through a WG environment, in accordance with various embodiments. The method 400 begins, at block 405, by providing an interface device associated with a user account. Similar to the description of FIG. 3, the interface device may be any device, or combination of devices, in the device chain between a client device and service provider network, that allows a client device to access and communicate with a service provider network. However, in the walled garden context, various embodiments may call for the interface device to be a residential gateway type device, such as a modem or set-top box.

At block 410, a connection is established, by the interface device, with at least one client device. As previously described with respect to FIG. 3, in some embodiments, the client devices may have already been connected to the interface device beforehand, for example, being powered back on. In other embodiments, the client devices may be connecting to the interface device for the first time.

At block 415, user account information is retrieved from a registration server. According to a set of embodiments, the registration server is configured to retrieve user account information associated with individual user accounts. According to one set of embodiments, the interface device may be connected to a service edge device. In one set of embodiments, the interface device may transmit identifying information to the service edge device, which then queries the registration server with the identifying information. In some embodiments, the registration server may then return user account information for the requested user account to the service edge device.

At block 420, it is determined whether to present a captive portal service offering page to the client device. In one set of embodiments, the user account information may indicate what services a user account associated with the interface device currently receives, and whether new services or an upgrade to exiting service is available to the customer. In some embodiments, the requesting service edge device may then determine whether to present applicable captive portal service offering pages to the client devices.

At block 425, if the service edge device determines not to present the captive portal service offering page to the client devices, the interface device presents the requested content to the client device normally. For example, in one set of embodiments, the service edge device may allow the interface device to access a service provider network, absent an indication in the user account information to restrict traffic originating from the interface device.

At block 430, if it is determined to present a service offering page, the service edge device establishes a tunnel into a walled garden. In various embodiments, the walled garden may be a closed network ecosystem comprising, among others, a captive portal server. According to one set of embodiments, the service edge device may establish an L2TP tunnel into the walled garden.

At block 435, the service edge device restricts traffic, to and from the interface device, to the walled garden. According to a set of embodiments, the user account information may indicate that a WG flag has been set for the user account. A WG flag may indicate to the service edge device that traffic from the interface device should be redirected to the WG. In other embodiments, the user account information may merely indicate that a new service or upgrade is available to the customer, and, in response, the service edge device may redirect traffic from the interface device to the walled garden.

At block 440, communications may be established, via the tunnel, with a captive portal server in the walled garden. According to one set of embodiments, the service edge device may connect to a WG LNS via the L2TP tunnel. The WG LNS may then redirect traffic from the interface device to the captive portal server. In various embodiments, the captive portal server may host various instances of captive portal service offering pages to be provided to the client devices.

At block 445, client devices are directed, via the interface device, to at least one captive portal service offering page. According to one set of embodiments, the client device may be directed to the captive portal server, and the captive portal server may provide the captive portal service offering pages to the client device. The captive portal server may receive the captive portal service offering pages from an advertising server. In some embodiments, the advertising server may be able to receive, or otherwise configured to allow a third party service provider to create, service offering pages. In various embodiments, the service offering pages may be specifically formatted for display on a respective type of client device. In some embodiments, multiple service offerings may be presented in the form of separate service offering pages. In other embodiments, a single service offering page may contain all or a portion of the multiple service offerings. In various embodiments, the client device may be directed to the service offering pages upon startup, or connection to the interface device. In some embodiments, the client devices may be presented with the service offering pages in the form of a popup or graphical overlay presented over the content requested by the client device. In yet further embodiments, the client devices may be redirected from the content currently being viewed to the service offering page.

At optional block 450, as described with respect to FIG. 3, if the interface device is a set-top box, the set-top box may be configured to provide a video stream that includes at least one captive portal service offering page.

At block 455, a user selection responsive to the at least one service offering page is received. According to one set of embodiments, the interface device may receive, via the at least one service offering page, a user selection indicating a response to the at least one service offering page. The interface device may then transmit the user selection to the captive portal server. The captive portal may then transmit the user selections to the registration server. As described above, with respect to FIG. 3, the user selection may include, without limitation, an acceptance of a service offering in the service offering page, rejection of the service offerings, a dismissal of the service offering page, a request to be reminded of the service offering at a later time, or other like responses.

At block 460, the registration server may then register the user account to receive a network service as indicated by the user selection. According to a set of embodiments, the registration server may be configured to implement the user selections. For example, in some embodiments, the user selection may indicate an acceptance of the service offering, and the registration server may register the user account to receive the new service or upgrade as indicated by the user selection, or to implement various configuration options as indicated by the user selection. In various embodiments, these selections may also be reflected by updates to the user account information. If the user selection indicates a rejection of the service offering, the registration server may update the user account information to reflect the customer's lack of interest in the service. In further embodiments, the registration server update the user account information to indicate that the service offering page should be withheld from being presented to the customer indefinitely, or for a specified period of time, if, for example, the customer wishes to be reminded of the service offering at a later time.

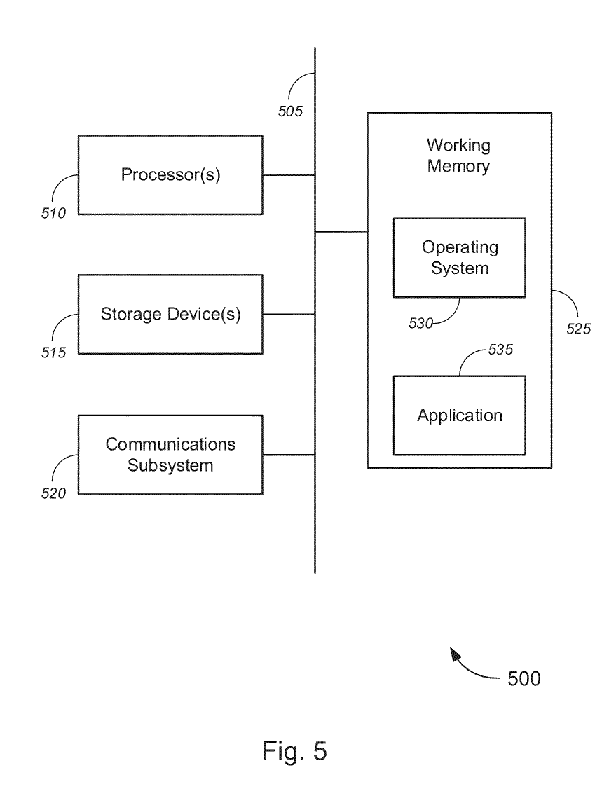

FIG. 5 is a block diagram of an exemplary computer architecture 500 that may be used for providing captive portal service offerings, in accordance with various embodiments. FIG. 5 provides a schematic illustration of one embodiment of a computer system 500 that can perform the methods provided by various other embodiments, as described herein, and/or can perform the functions of the user devices, the service edge devices, authentication system, captive portal server, or any other computer systems as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or integrated manner.

The computer system 500 includes a plurality of hardware elements that can be electrically coupled via a bus 505 (or may otherwise be in communication, as appropriate). The hardware elements may include one or more processors 510, including, without limitation, one or more general-purpose processors and/or one or more special-purpose processors (such as digital signal processing chips, graphics acceleration processors, and/or the like).

The computer system 500 may further include, or be in communication with, one or more storage devices 515. The one or more storage devices 515 can comprise, without limitation, local and/or network accessible storage, or can include, without limitation, a disk drive, a drive array, an optical storage device, a solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including, without limitation, various file systems, database structures, or the like.

The computer system 500 might also include a communications subsystem 520, which can include, without limitation, a modem, a network card (wireless or wired), a wireless programmable radio, or a wireless communication device. Wireless communication devices may further include, without limitation, a Bluetooth device, an 802.11 device, a WiFi device, a WiMax device, a WWAN device, cellular communication facilities, or the like. The communications subsystem 520 may permit data to be exchanged with a customer premises, residential gateway, integrated residential gateway, authentication server, walled garden, or combination of the above elements, as described above. Communications subsystem 520 may also permit data to be exchanged with other computer systems, and/or with any other devices described herein, or with any combination of network, systems, and devices. According to some embodiments, the network might include a local area network (“LAN”), including without limitation a fiber network, or an Ethernet network; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol, or any other wireless protocol; or any combination of these or other networks.

In many embodiments, the computer system 500 will further comprise a working memory 525, which can include a RAM or ROM device, as described above. The computer system 500 also may comprise software elements, shown as being currently located within the working memory 525, including an operating system 530, device drivers, executable libraries, and/or other code. The software elements may include one or more application programs 535, which may comprise computer programs provided by various embodiments, and/or may be designed to implement methods and/or configure systems provided by other embodiments, as described herein.

By way of example, one or more procedures described with respect to the methods discussed herein might be implemented as code and/or instructions executable by a computer (and/or a processor within a computer). In an aspect, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 515 described above. In some cases, the storage medium 515 might be incorporated within a computer system 500. In other embodiments, the storage medium might be separate from the computer system 500, in the form of a removable medium, such as an optical disc, USB flash drive, or the like. In some embodiments, the storage medium might be provided in an installation package, such that the storage medium can be used to program, configure, and/or adapt a general purpose computer with the instructions/code stored thereon. These instructions might take the form of executable code, which is executable by the processor(s) 500 and/or might take the form of source and/or installable code. The source or installable code, upon compilation, installation, or both compilation and installation, on the computer system 500 might take the form of executable code. Compilation or installation might be performed using any of a variety of generally available compilers, installation programs, compression/decompression utilities, or the like.

It will be apparent to those skilled in the art that substantial variations may be made in accordance with specific requirements. For example, customized hardware—such as programmable logic controllers, field-programmable gate arrays, application-specific integrated circuits, and/or the like—might also be used. In some cases, particular elements might be implemented in hardware, software (including portable software, such as applets, etc.), or both. Further, connection to other computing devices such as network input/output devices may be employed.

As mentioned above, in one aspect, some embodiments may employ a computer system 500 to perform methods in accordance with various embodiments of the invention. According to a set of embodiments, some or all of the procedures of such methods are performed by the computer system 500 in response to processor 510 executing one or more sequences of one or more instructions. The one or more instructions might be incorporated into the operating system 530 and/or other code that may be contained in working memory 525, such as an application program 535. Such instructions may be read into the working memory 525 from another computer readable medium, such as one or more of the storage device(s) 515. Merely by way of example, execution of the sequences of instructions contained in the working memory 525 might cause the processor(s) 510 to perform one or more procedures of the methods described herein.

The terms “machine readable medium” and “computer readable medium,” as used herein, refer to any medium that participates in providing data that causes a machine to operation in a specific fashion. In one set of embodiments, various computer readable media might be involved in providing instructions/code to processor(s) 510 for execution, might be used to store and/or carry such instructions/code such as signals, or both. In many implementations, a computer readable medium is a non-transitory, physical, and/or tangible storage medium. Such a medium may take many forms, including, but not limited to, non-volatile media, volatile media, and transmission media. Non-volatile media includes, for example, optical disks, magnetic disks, or both, such as the storage device(s) 515. Volatile media includes, without limitation, dynamic memory, such as the working memory 525. Transmission media includes, without limitation, coaxial cables, copper wire and fiber optics, including the wires that comprise the bus 505, as well as the various components of the communication subsystem 520, and/or the media by which the communications subsystem 520 provides communication with other devices. Hence, transmission media can also take the form of waves, including, without limitation, radio, acoustic, and/or light waves, such as those generated during radio-wave and infra-red data communications.

Common forms of physical or tangible computer readable media include, for example, a floppy disk, a flexible disk, a hard disk, magnetic tape, or any other magnetic medium; a CD-ROM, DVD-ROM, or any other optical medium; punch cards, paper tape, or any other physical medium; a RAM, a PROM, an EPROM, a FLASH-EPROM, or any other memory chip or cartridge; a carrier wave; or any other medium from which a computer can read instructions or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 520 (and/or components thereof) generally will receive the signals, and the bus 505 then might carry the signals (and/or the data, instructions, etc. carried by the signals) to the working memory 525, from which the processor(s) 510 retrieves and executes the instructions. The instructions received by the working memory 525 may optionally be stored on a storage device 515 either before or after execution by the processor(s) 510.

According to a set of embodiments, the computer system 500 may provide a connection between at least one client device and a service provider network. The connection may be a wired connection utilizing Ethernet, broadband cable, or optical fiber, or a wireless connection utilizing any of a WiFi, 3G, 4G, or other wireless data connection. Through the communications subsystem 520, the computer system 500 may be able to communicate with an advertising server to receive and store various captive portal service offering pages. In alternative embodiments, the computer system 500 may communicate identifying information to a service edge device. The service edge device may then determine user account information from which the service edge device may redirect traffic from the computer system 500 into a WG.

The computer system may then present a captive portal service offering page to a connected client device, receive user selections responsive to the captive portal service offerings, and ultimately transmit the user selections to a registration server for provisioning.

In various embodiments, the computer system 500 might have identifying information that associates the computer system 500 itself with a user account. In alternative embodiments, the computer system 500 may merely receive identifying information from another interface device. The computer system 500 may transmit the identifying information to a registration server that subsequently retrieves user account information. In various embodiments, the user account information may indicate whether new services or upgrades to existing service are available to a customer associated with the user account. In further embodiments, the user account information may indicate whether and what service offering pages to present to a client device. In yet further embodiments, the user account information may indicate whether or not a WG flag has been set for user account. If a WG flag has been set, traffic from the customer premises are redirected to a WG. In various embodiments, an L2TP tunnel may be established into the WG. In one set of embodiments, the WG may comprise various captive portal service offering pages, accessible via a captive portal server. The captive portal server may host a web application for activating services as indicated by a user selection.

Upon receiving the user selections, the computer system 500 may transmit the user selections to a registration server. In various embodiments, this may include registering a user account to receive services as indicated by the user selections. In some embodiments, this may involve updating user account information as indicated in the user selections. This may include, without limitation, updating user account information regarding what services are currently received, what upgrades are available, and whether to present a captive portal service offering page; removing a WG flag from the user account information; or other actions described in further detail with respect to the above embodiments.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture, but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A captive portal service offering system comprising:
an advertising server hosting at least one captive portal service offering page, wherein the advertising server is configured to both send and receive captive portal service offering pages;
a registration server configured to provide user account information associated with a user account, the user account information indicating whether the user account qualifies for a network service offered by the at least one captive portal service offering page, and to register the user account for the network service offered by the at least one captive portal service offering page;
an interface device associated with the user account and in communication with at least one client device, the interface device comprising:
at least one processor;
non-transitory computer readable media having encoded thereon computer software comprising a set of instructions executable by the at least one processor to perform one or more operations, the set of instructions comprising:
instructions to retrieve, from the registration server, user account information associated with the user account;
instructions to determine, based on the user account information, whether to present the at least one captive portal service offering page to the at least one client device;
instructions to direct, in response to a determination to present the at least one captive portal service offering page, one or more of the at least one client device to the at least one captive portal service offering page;
instructions to receive, via the at least one captive portal service offering page, a user selection of the network service offered by the at least one captive portal service offering page; and
instructions to transmit the user selection to the registration server.

2. The captive portal service offering system of claim 1, wherein the set of instructions further comprises:
instructions to transmit an identifier of the at least one client device to the registration server; and
instructions to associate the at least one client device with the user account.

3. The captive portal service offering system of claim 2, further comprising instructions to alert each of the at least one client device of an availability of the network service.

4. The captive portal service offering system of claim 1, wherein each of the at least one captive portal pages are formatted respectively for each of the at least one client device.

5. The captive portal service offering system of claim 1, wherein the set of instructions further comprises:
instructions to receive, from the advertising server, the at least one captive portal service offering page;
wherein the at least one client device is directed to the at least one captive portal service offering page stored on the interface device.

6. The captive portal service offering system of claim 1, wherein the set of instructions further comprises:
instructions to establish a tunnel into a walled garden;
instructions to restrict access by the at least one client device to the walled garden; and
instructions to redirect, via the tunnel, the at least one client device to a captive portal server in the walled garden, wherein the captive portal server presents the at least one captive portal service offering page to the at least one client device, and wherein the captive portal server receives the at least one captive portal service offering page from the advertising server.

7. The captive portal service offering system of claim 1, wherein the advertising server is configured to receive the at least one captive portal service offering page from an advertiser.

8. The captive portal service offering system of claim 1, wherein the at least one client device is directed to the at least one captive portal service offering page upon occurrence of a condition selected from the group consisting of startup of the at least one client device, connection by the at least one client device to the interface device, or attempt by the client device to access a service provider network.

9. The captive portal service offering system of claim 1, wherein the interface device comprises a set-top box, wherein the set of instructions further comprises instructions to provide a video stream to the at least one client device, wherein the video stream includes the at least one captive portal service offering page.

10. The captive portal service offering system of claim 1, wherein the at least one captive portal service offering page is presented concurrently with other content requested by the at least one client device.

11. A device for captive portal service offerings, the device associated with a user account and in communication with at least one client device, the device comprising:
at least one processor;
non-transitory computer readable media having encoded thereon computer software comprising a set of instructions executable by the at least one processor to perform one or more operations, the set of instructions comprising:
instructions to retrieve, from a registration server, user account information associated with the user account;
instructions to determine, based on the user account information, whether to present the at least one captive portal service offering page to the at least one client device;
instructions to direct, in response to a determination to present the at least one captive portal service offering page, one or more of the at least one client device to display the at least one captive portal service offering page;
instructions to receive, via the at least one captive portal service offering page, a user selection of the network service offered by the at least one captive portal service offering page; and
instructions to transmit the user selection to the registration server.

12. The device of claim 11, wherein the set of instructions further comprises:
instructions to transmit an identifier of the at least one client device to the registration server; and
instructions to associate the at least one client device with the user account.

13. The device of claim 12, further comprising instructions to alert each of the at least one client device of an availability of the network service.

14. The device of claim 11, wherein the set of instructions further comprises:
instructions to receive, from an advertising server, the at least one captive portal service offering page;
wherein the at least one client device is directed locally to the received at least one captive portal service offering page.

15. The device of claim 11, wherein the set of instructions further comprises:
instructions to establish a tunnel into a walled garden;
instructions to restrict access by the at least one client device to the walled garden; and
instructions to redirect, via the tunnel, the at least one client device to a captive portal server in the walled garden, wherein the captive portal server presents the at least one captive portal service offering page to the at least one client device, and wherein the captive portal server receives the at least one captive portal service offering page from the advertising server.

16. The device of claim 11, wherein the set of instructions further comprises instructions to provide a video stream to the at least one client device, wherein the video stream includes the at least one captive portal service offering page.

17. A method for providing captive portal service offerings comprising:
providing an interface device associated with a user account;
establishing, via the interface device, a connection with at least one client device;
retrieving, via a registration server, user account information associated with the user account;
determining, based on the user account information, whether to present at least one captive portal service offering page to the at least one client device;
directing, via the interface device, the at least one client device to the at least one captive portal service offering page;
receiving, via the at least one captive portal service offering page, a user selection of a network service offered by the at least one captive portal service offering page; and
transmitting, via the interface device, the user selection to the registration server.

18. The method of claim 17 further comprising:
receiving, with the interface device, the at least one captive portal service offering page; and
storing, at the interface device, the at least one captive portal service offering page locally;
wherein the at least one client device is directed to the at least one captive portal service offering page stored on the interface device.

19. The method of claim 17 further comprising:
establishing, via the interface device, a tunnel into a walled garden;
restricting, via the interface device, access by the at least one client device to the walled garden; and
redirecting, via the tunnel, the at least one client device to a captive portal server in the walled garden, wherein the captive portal server presents the at least one captive portal service offering page to the at least one client device, and wherein the captive portal server receives the at least one captive portal service offering page from the advertising server.

20. The method of claim 17 further comprising:
providing, via the interface device, a video stream to the at least one client device, wherein the interface device comprises a set-top box, and wherein the video stream includes the at least one captive portal service offering page.
